(19) United States
(12) Patent Application Publication
(10) Pub. No.: US 2025/0211041 A1
(43) Pub. Date: Jun. 26, 2025

(54) ROTOR OF AN ELECTRIC MACHINE

(71) Applicant: Robert Bosch GmbH, Stuttgart (DE)

(72) Inventors: Dominik Flore, Schwieberdingen (DE); Kurt Reutlinger, Stuttgart (DE)

(21) Appl. No.: 18/850,126

(22) PCT Filed: Mar. 6, 2023
(86) PCT No.: PCT/EP2023/055548

§ 371 Date: Sep. 24, 2024

(30) Foreign Application Priority Data
Mar. 30, 2022 (DE) 10 2022 203 125.3

(51) Int. Cl. H02K 1/276; H02K 1/32

(52) U.S. Cl. CPC H02K 1/276; H02K 1/32

(57) ABSTRACT

The invention relates to a rotor (2) of an electric machine (1), comprising a rotor support (4), in particular a rotor shaft, which can be rotated about a rotor axis (3), a rotor sleeve (5), in particular a fiber composite sleeve, and a rotor body (6) which is arranged between the rotor support (4) and the rotor sleeve (5) and which comprises multiple rotor poles (7) and at least one magnet pocket (8) per rotor pole (7) for receiving magnets (9), in particular permanent magnets. The rotor body (6) has at least one base body (10), said base body being supported on the rotor support (4) radially inside the magnet pockets (8) with respect to the rotor axis (3), and outer segment bodies (11) radially outside the magnet pockets (8). The invention is characterized in that—multiple base bodies (10) are provided one behind the other in a circumferential direction,—a radial separation (14) which is continuous in the radial direction is formed between each pair of adjacent base bodies (10) in the region radially within each magnet pocket (8) in order to allow a radial movement of the base bodies (10), and—the base bodies (10) can be clamped between the rotor support (4) and the rotor sleeve (5) in order to clamp the magnets (9) in the magnet pockets (8), in particular by virtue of an oversize of the rotor support (4) or by winding the rotor sleeve (5) under tension.

### BACKGROUND

The invention proceeds from a rotor of an electric machine.

A rotor of an electric machine is already known from WO 2021/225902 A1, comprising a rotor support, in particular a rotor shaft, which can be rotated about a rotor axis, a rotor sleeve embodied as a fiber composite sleeve and a rotor body which is arranged between the rotor support and the rotor sleeve and which comprises multiple rotor poles and at least one magnet pocket per rotor pole for receiving magnets, in particular permanent magnets. The rotor body has a base body, said base body being supported on the rotor support radially inside the magnet pockets with respect to the rotor axis, and outer segment bodies radially outside the magnet pockets.

The magnets located in the magnet pockets can be braced in the radial direction between the respective outer segment body and the base body by winding the fibers of the composite sleeve onto the rotor body under tension. This method requires comparatively high-strength fibers that are comparatively expensive, because the fibers are not yet fixedly connected by a plastic matrix when wound and are thus less resilient. In addition, the manufacture of such a fiber composite sleeve is comparatively time consuming and expensive as the winding is performed separately for each rotor.

### SUMMARY

In contrast, the rotor of an electric machine according to the invention with the characterizing features of the main claim has the advantage that the clamping of the magnets into the magnet pockets is technically simplified. A further advantage is that higher preloads can be achieved in the rotor sleeve, which means that less deformation occurs on the outer circumference of the rotor under speed load, so that higher speeds are possible for the rotor.

These advantages can be achieved according to the invention by providing multiple base bodies one behind the other in the circumferential direction, by forming a radial separation which is continuous in the radial direction between each pair of adjacent base bodies in the region radially within each magnet pocket, in order to allow a radial movement of the base bodies and by bracing the base bodies between the rotor support and rotor sleeve to clamp the magnets in the magnet pockets, in particular by means of an oversize of the rotor support according to a first embodiment or by winding the rotor sleeve under tension according to a second embodiment.

According to the first embodiment, the base bodies are moved in the radial direction towards the rotor sleeve when the rotor support is inserted into the rotor body due to an oversize of the rotor support, so that a preload is generated in the rotor sleeve due to a deformation of the rotor sleeve, which leads to the magnets being clamped in the magnet pockets. Since the magnets are clamped in the magnet pocket after insertion of the magnets into the magnet pockets, damage to the magnets, in particular a coating of the magnets, is avoided when inserting the magnets into the magnet pockets. Furthermore, according to the present invention, very low air gaps can be achieved between the respective magnet pocket of the rotor body and the respective magnet.

The measures listed in the dependent claims enable advantageous further developments and improvements of the rotor of an electric machine specified in the main claim.

According to the advantageous first embodiment, it is provided that the rotor support is inserted into the rotor with pressing in the axial direction, such that the base bodies are each moved in the radial direction with an expansion of the radial separations, whereby a preload in the rotor sleeve and consequently the clamping of the magnets in the magnet pocket can be achieved. In this way, the rotor sleeve may be a pre-assembled fiber composite sleeve into which the base bodies, the outer segment bodies and the magnets can be inserted with a clearance fit and in which a preload can subsequently be generated by means of the rotor support. A rotor sleeve, which is pre-assembled independently of the individual rotor, has the advantage that it can be manufactured with a multiple length of the rotor and then divided into multiple rotor sleeves. This may reduce the manufacturing cost of the rotor.

According to a first exemplary embodiment, it is particularly advantageous if adjacent base bodies each have flat separating surfaces facing each other at a distance to form the respective radial separation. In this way, a separating slot is formed between adjacent base bodies in the region radially within the respective magnet pocket, which is continuous in the axial and radial direction. The first exemplary embodiment has the advantage that the rotor can be easily manufactured. Furthermore, the first exemplary embodiment has the slight disadvantage that the radial separation slightly increases the magnetic flux resistance in the respective rotor pole.

It is further advantageous if, according to a second exemplary embodiment, adjacent base bodies each have a separation interface for forming the respective radial separation, wherein the respective separation interface is formed by the adjacent base bodies engaging in each other by means of overlapping sheet metal segments. The second exemplary embodiment has the advantage that the disadvantageous increase of the magnetic flux resistance in the respective rotor pole is at least reduced by an axial bridging of the respective radial separation of the base bodies.

It is very advantageous if at least one, in particular each, of the base bodies has on its inner circumference a shaped contour for transferring torque, in particular a protrusion or recess, which cooperates with a corresponding counter-shaped contour of the rotor support, in particular in a form-fit manner. In this way, the rotor can transmit a higher maximum torque, especially at high speeds.

It is also advantageous if a magnetic cooling channel is provided in each of the magnet pockets for cooling the magnets, which is flow-connected to a cooling channel formed in the rotor support via a separating slot formed by the respective radial separation. In this way, the cooling of the magnets in the magnet pockets can be improved.

It is also advantageous if the outer segment bodies and the base bodies are connected to each other by means of bridging webs, which are located on the outer circumference of the rotor body or are each designed as separate laminated cores. The connection of the outer segment bodies and the base bodies via the bridging webs facilitates the manufacture of the rotor as the assembly effort decreases. The bridging webs are deformed upon radial displacement of the base bodies.

In addition, it is advantageous if the rotor body according to a first embodiment is formed by a package of circular laminations, wherein the laminations each have slots for creating the radial separation of the base bodies.

Advantageously, according to a second embodiment, the rotor body is formed by a flat package of contoured sheet metal strips, wherein the contoured sheet metal strips each comprise first sheet metal segments for forming the outer segment bodies and second sheet metal segments for forming the base bodies, wherein the sheet metal segments of the respective contoured sheet metal strip are connected to each other by means of the bridging webs, wherein the flat package is bent around the rotor support, wherein the ends of the flat package of contoured sheet metal strips lie adjacent to each other in the circumferential direction. In this way, the manufacturing costs can be reduced since the sheet metal waste when cutting out the contoured sheet metal strips can be significantly reduced, especially if the stator is manufactured in a similar linearly unwound manner.

In addition, it is advantageous if the rotor body according to a third embodiment is formed by spiral or helical upright rolling of a contoured sheet metal strip around the rotor support, wherein the contoured sheet metal strip comprises first sheet metal segments for forming the outer segment bodies and second sheet metal segments for forming the base bodies, wherein the sheet metal segments of the contoured sheet metal strip are connected to each other by means of the bridging web. In this way, the manufacturing costs can be reduced since the sheet metal waste when cutting out the contoured sheet metal strips can be significantly reduced.

In addition, it is advantageous if the rotor sleeve is a fiber composite sleeve comprising a fiber winding, in particular of glass fiber or carbon fiber, and a cured composite material for embedding the fiber winding. In this way, high preloads can be produced or received with the rotor sleeve, as the fibers are embedded in the cured composite and can therefore withstand higher loads.

In an advantageous manner, the magnet pockets can each be U-shaped, V-shaped, C-shaped and each have two, in particular mirror-symmetrical, pocket legs, wherein each of the pocket legs is configured to receive at least one of the magnets. In this way, the maximum torque of the electric machine that can be generated may be increased.

The invention also relates to an electrical machine with a rotor according to the invention.

### BRIEF DESCRIPTION OF THE DRAWINGS

An exemplary embodiment of the invention is shown in simplified form in the drawing and explained in more detail in the following description.

FIG. 1 shows a rotor of an electric machine according to the invention,

FIG. 2 shows a sectional view of the rotor according to the invention according to FIG. 1,

FIG. 3 shows a radially inward view of a part of one of the rotor poles of the rotor body according to the invention according to FIG. 1 and FIG. 2 according to a first exemplary embodiment,

FIG. 4 shows a radially inward view of a part of one of the rotor poles of the rotor body according to the invention according to FIG. 1 and FIG. 2 according to a second exemplary embodiment,

FIG. 5 shows one of the rotor poles of the rotor according to the invention according to FIG. 1 to FIG. 3 according to the first exemplary embodiment,

FIG. 6 shows two contoured sheet metal strips for manufacturing the rotor according to the invention,

FIG. 7 shows a bending of a contoured sheet metal strip around a rotor support according to FIG. 1 and FIG. 2 for manufacturing the rotor according to the invention,

FIG. 8 shows the rotor of FIG. 2 according to the second exemplary embodiment according to FIG. 4.

### DETAILED DESCRIPTION

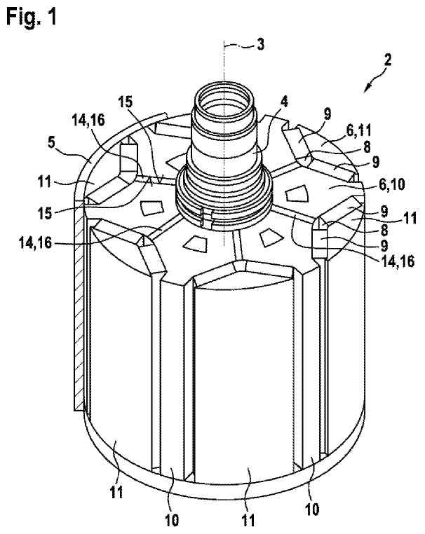

FIG. 1 shows a rotor of an electric machine according to the invention. The rotor 2 of an electric machine 1 according to the invention comprises a rotor support 4, in particular a rotor shaft, which can be rotated about a rotor axis 3, a rotor sleeve 5, and a rotor body 6, which is arranged between the rotor support 4 and the rotor sleeve 5. The rotor body 6 has multiple rotor poles 7 and at least one magnet pocket 8 per rotor pole 7 for receiving magnets 9, in particular permanent magnets. The rotor body 6 has at least one base body 10, said base body being supported on the rotor support 4 radially inside the magnet pockets 8 with respect to the rotor axis 3, and outer segment bodies 11 radially outside the magnet pockets 8.

The outer segment bodies 11 thus extend in the radial direction from the rotor sleeve 5 to the respective magnet pocket 8. The base bodies 10 each extend in the radial direction from the rotor sleeve 5 to the rotor support 4.

The base bodies 10 and/or the outer segment bodies 11 are each formed from a sheet metal packet of sheet metal segments 12. The sheet metal segments 12 of each sheet metal packet are in particular joined together, for example by punching, gluing, or welding.

The rotor sleeve 5 is, for example, a fiber composite sleeve that comprises a fiber winding, in particular made of glass fiber or carbon fiber, and a cured composite material for embedding the fiber winding. The rotor sleeve may be a pre-assembled fiber composite sleeve or a fiber composite sleeve wound onto the rotor body 6. In the case of a fiber composite sleeve wound on the rotor body 6, a fiber winding is first wound on and the composite material is subsequently applied in a liquid form.

The magnet pockets 8 can, for example, each be U-shaped, V-shaped, C-shaped and each have two, in particular mirror-symmetrical, pocket legs 8.1. Each of the pocket legs 8.1 is provided for receiving at least one of the magnets 9.

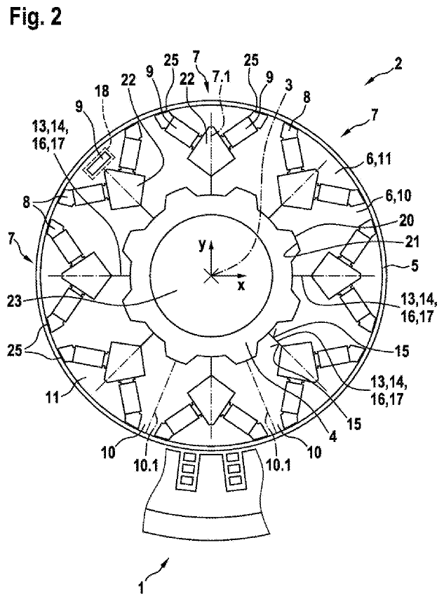

FIG. 2 shows a sectional view of the rotor according to the invention according to FIG. 1.

According to the invention, multiple base bodies 10 are provided one behind the other in a circumferential direction with respect to the rotor axis 3. Furthermore, according to the present invention, a radial separation 14 which is continuous in the radial direction is formed between each pair of adjacent base bodies 10 in the region radially within each magnet pocket 8 with respect to the rotor axis 3 in order to allow a radial movement of the base bodies 10. Furthermore, the base bodies 10 can be clamped between the rotor support 4 and the rotor sleeve 5 in order to clamp the magnets 9 in the magnet pockets 8, for example by virtue of an oversize of the rotor support 4 or by winding the rotor sleeve 5 under tension.

The radial separation 14 ensures that each outer segment body 11 has two adjacent base bodies 10 in the circumferential direction with respect to the rotor axis 3 and vice versa.

The base bodies 10 expand radially inwards towards the rotor support 4 in the circumferential direction and can, for example, be in the form of an isosceles trapezoid, T-shaped, mushroom-shaped, umbrella-shaped, wedge-shaped or fir-tree-shaped.

The outer segment bodies 11 are circular in cross section, for example. In addition, at least one further magnet pocket 18 can be provided in each of the outer segment bodies 11 to receive one of the magnets 8.

The radial separation 14 can be located in the region of a pole center 7.1 of the respective rotor pole 7, in particular in the pole center 7.1. The rotor poles 7 are formed in the circumferential direction between two pole edges, wherein a central axis 10.1 of the respective base body 10 forms, for example, one of the two pole edges of one of the rotor poles 7 and, for example, the central axes 10.1 of adjacent base bodies 10 each limit one of the rotor poles 7 in the circumferential direction.

According to a first embodiment, the rotor support 4 can be inserted into the rotor 2 with a pressing in the axial direction generated by the oversize, such that the base bodies 10 are each moved in the radial direction with an expansion of the radial separations 14, whereby a preload in the rotor sleeve 5 and consequently the clamping of the magnets 9 in the magnet pockets 8 can be achieved.

At least one, in particular each, of the base bodies 10 has a shaped contour 20 for transferring torque, in particular a protrusion or recess, on its inner circumference facing the rotor support 4, which cooperates with a corresponding counter-shaped contour 21 of the rotor support 4, in particular in a form-fit manner. According to FIG. 2, the shaped contour 20 is configured as a recess, for example, and the counter-shaped contour 21 of the rotor support 4 is configured as a tooth-shaped projection, for example. The shaped contour 20 and the counter-shaped contour 21 are, for example, designed without undercuts in the radial direction.

The outer segment bodies 11 and the base bodies 10 can be connected to each other by means of bridging webs 25, which are located on an outer circumference of the rotor body 6 facing the rotor sleeve 5 or can each be provided as separate laminated cores.

According to a first embodiment, the rotor body 6 can be formed by a package of circular laminations, wherein the circular laminations each have sheet metal slots 13 for producing the radial separation 14 of the base bodies 10.

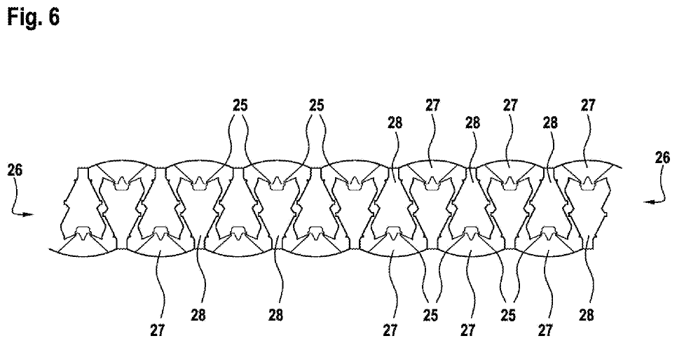

Alternatively, according to a second embodiment, the rotor body 6 can be formed by a so-called flat package of contoured sheet metal strips 26. The contoured sheet metal strips 26 each comprise first sheet metal segments 27 for forming the outer segment bodies 11 and second sheet metal segments 28 for forming the base bodies 10. The sheet metal segments 27, 28 of the respective contoured sheet metal strip 26 are connected to one another by means of the bridging webs 25, such that the contoured sheet metal strip 26 forms a segment chain. FIG. 6 shows two nested segment chains that can be punched or cut out of a straight sheet metal strip with little sheet metal waste, and then stacked with further segment chains to form the flat package. According to the second embodiment, the flat package 6 is bent around the rotor support 4, wherein the ends of the flat package 6 of contoured sheet metal strips 26 are located adjacent to one another in the circumferential direction. The contoured sheet metal strips 25 according to the second embodiment thus have a length corresponding to the circumference of the rotor body 6.

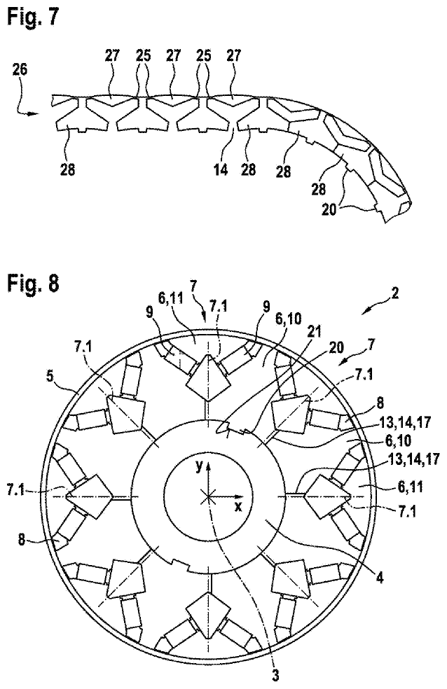

According to a third embodiment, the rotor body 6 can also be formed by a spiral or helical winding, i.e., a so-called upright rolling, of a sheet metal strip 26 contoured according to FIG. 6 or FIG. 7 around the rotor support 4. As in the second embodiment, the contoured sheet metal strip 26 comprises first sheet metal segments 27 for forming the outer segment bodies 11 and second sheet metal segments 28 for forming the base bodies 10, wherein the sheet metal segments 27, 28 of the contoured sheet metal strip 26 are also connected to one another by means of the bridging webs 25. The contoured sheet metal strip 25 according to the third embodiment has a length corresponding to a multiple of the circumference of the rotor body 6 due to the helical winding.

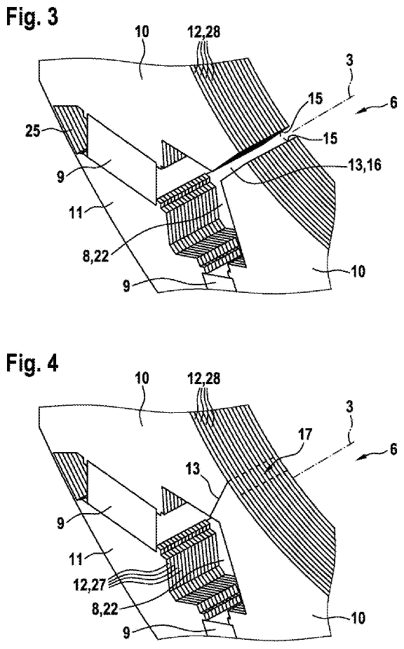

FIG. 3 shows a radial inward view of a part of one of the rotor poles of the rotor body according to the invention according to FIG. 1 and FIG. 2 according to a first exemplary embodiment.

According to the first exemplary embodiment, adjacent base bodies 10 each have flat separating surfaces 15 facing each other at a distance to form the respective radial separation 14. In this way, a separating slot 16 is formed between adjacent base bodies 10 in the region radially within the respective magnet pocket 8, which is continuous in the axial and radial direction.

FIG. 4 shows a radial inward view of a part of one of the rotor poles of the rotor body according to the invention according to FIG. 1 and FIG. 2 according to a second exemplary embodiment.

According to the second exemplary embodiment, adjacent base bodies 10 each have a separation interface 17 for forming the respective radial separation 14, wherein the respective separation interface 17 is formed by adjacent base bodies 10 engaging in each other by means of overlapping sheet metal segments 12.

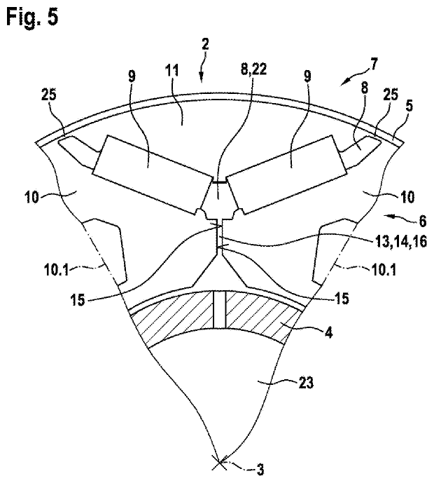

FIG. 5 shows one of the rotor poles of the rotor according to the invention according to FIG. 1 to FIG. 3 according to the first exemplary embodiment.

A magnetic cooling channel 22 for cooling the magnets 9 can be provided in the magnet pockets 8 of the rotor 2, which is flow-connected via the respective separating slot 16 to a cooling channel 23 formed in the rotor support 4.

FIG. 8 shows the rotor according to FIG. 2 according to the second exemplary embodiment according to FIG. 4.

The separation interfaces 17 may be formed for a rotor body 6, for example, by providing radial separation 14 with the sheet metal slot 13 alternately off-center to the right or off-center to the left as seen in the circumferential direction of the rotor 2 from the rotor pole 7 to the next rotor pole 7.

1. A rotor (2) of an electric machine (1), comprising a rotor support (4), which can be rotated about a rotor axis (3), a rotor sleeve (5), and a rotor body (6), which is arranged between the rotor support (4) and the rotor sleeve (5) and which comprises multiple rotor poles (7) and at least one magnet pocket (8) per rotor pole (7) for receiving magnets (9), wherein the rotor body (6) has at least one base body (10), said base body being supported on the rotor support (4) radially inside the magnet pockets (8) with respect to the rotor axis (3), and outer segment bodies (11) radially outside the magnet pockets (8), wherein:
multiple base bodies (10) are provided one behind the other in a circumferential direction,
a radial separation (14) which is continuous in a radial direction is formed between each pair of adjacent base bodies (10) in a region radially within each magnet pocket (8) in order to allow a radial movement of the base bodies (10),
the base bodies (10) can be clamped between the rotor support (4) and the rotor sleeve (5) in order to clamp the magnets (9) in the magnet pockets (8).

2. The rotor according to claim 1, wherein the rotor support (4) is inserted in the rotor (2) with pressing in an axial direction, such that the base bodies (10) are each moved in the radial direction with an expansion of the radial separations (14), whereby a preload in the rotor sleeve (5) and consequently the clamping of the magnets (9) in the magnet pockets (8) can be achieved.

3. The rotor according to claim 1, wherein:
a. adjacent base bodies (10) each have flat separating surfaces (15) facing each other at a distance to form the respective radial separation (14), or
b. adjacent base bodies (10) each have a separation interface (17) to form the respective radial separation (14), wherein the respective separation interface (17) is formed by the adjacent base bodies (10) engaging in each other by overlapping sheet metal segments (12).

4. The rotor according to claim 1, wherein at least one, of the base bodies (10) has on its inner circumference a shaped contour (20) for transferring torque, which cooperates with a corresponding counter-shaped contour (21) of the rotor support (4).

5. The rotor according to claim 1, wherein a magnetic cooling channel (22) for cooling the magnets (9) is provided in each of the magnet pockets (8) and is flow-connected to a cooling channel (23) formed in the rotor support (4) via a separating slot (16) formed by the respective radial separation (14).

6. The rotor according to claim 1, wherein the outer segment bodies (11) and the base bodies (10) are connected to each other by bridging webs (25), which are located on an outer circumference of the rotor body (6) or are each configured as separate laminated cores.

7. The rotor according to claim 6, wherein the rotor body (6) is formed by a package of circular laminations, wherein the laminations each have sheet metal slots for generating the radial separation (14) of the base bodies (10).

8. The rotor according to claim 6, wherein the rotor body (6) is formed by a flat package of contoured sheet metal strips (26), wherein the contoured sheet metal strips (26) each comprise first sheet metal segments (27) for forming the outer segment bodies (11) and second sheet metal segments (28) for forming the base bodies (10), wherein the sheet metal segments (27, 28) of the respective contoured sheet metal strip (26) are connected to each other by the bridging webs (25), wherein the flat package is bent around the rotor support (4), wherein the ends of the flat package of contoured sheet metal strips (26) are located adjacent to each other in the circumferential direction.

9. The rotor according to claim 6, wherein the rotor body (6) is formed by spiral or helical upright rolling of a contoured sheet metal strip (26) around the rotor support (4), wherein the contoured sheet metal strip (26) comprises first sheet metal segments (27) for forming the outer segment bodies (11) and second sheet metal segments (28) for forming the base bodies (10), wherein the sheet metal segments (27, 28) of the contoured sheet metal strip (26) are connected to each other by the bridging webs (25).

10. The rotor according to claim 1, wherein the rotor sleeve (5) is a fiber composite sleeve comprising a fiber winding, and a cured composite material for embedding the fiber winding.

11. The rotor according to claim 1, wherein the magnet pockets (8) are each U-shaped, V-shaped, or C-shaped and each have two, pocket legs (8.1), wherein each of the pocket legs (8.1) is configured to receive at least one of the magnets (9).

12. An electric machine with a rotor (2) according to claim 1.

13. The rotor according to claim 1, wherein the rotor support (4), is a rotor shaft.

14. The rotor according to claim 1, wherein the rotor sleeve (5) is a fiber composite sleeve.

15. The rotor according to claim 1, wherein the magnets (9) are permanent magnets.

16. The rotor according to claim 1, wherein the base bodies (10) can be clamped between the rotor support (4) and the rotor sleeve (5) by virtue of an oversize of the rotor support (4) or by winding the rotor sleeve (5) under tension.

17. The rotor according to claim 4, wherein the shaped contour (20) for transferring torque includes a protrusion or recess.

18. The rotor according to claim 10, wherein the fiber winding is glass fiber or carbon fiber.

19. The rotor according to claim 11, wherein the two pocket legs (8.1) are mirror-symmetrical.
